(19) United States
(12) Patent Application Publication
(10) Pub. No.: US 2026/0117723 A1
(43) Pub. Date: Apr. 30, 2026

(54) DUTY CYCLE CONTROL FOR METERING VALVE

(71) Applicant: Caterpillar Inc, Peoria, IL (US)

(72) Inventors: Ryan M. HINRICHSEN, Groveland, IL (US); Payton JOHNSON, Peoria, IL (US); Daniel R. PUCKETT, Peoria, IL (US); Dustin K. FEE, Peoria, IL (US)

(73) Assignee: Caterpillar Inc, Peoria, IL (US)

(21) Appl. No.: 18/930,027

(22) Filed: Oct. 29, 2024

(51) Int. Cl. F02D 41/38; F02D 41/14

(52) U.S. Cl. CPC F02D 41/3845; F02D 2041/1409; F02D 2041/141

(57) ABSTRACT

In one instance, disclosed herein is an engine system including: an engine; a common rail fluidly connected to the engine; a fuel pump connected to the common rail by an inlet line, the fuel pump configured to pump fuel through the inlet line to the common rail, the fuel pump including a metering valve; a fuel tank fluidly connected to the fuel pump; and an engine control module configured to provide a signal having a duty cycle to control operation of the metering valve to pump fuel from the fuel tank to the common rail, where the duty cycle of the signal is based on a first factor, and the first factor is based on a voltage of the signal and a desired average current to be supplied to the metering valve as a result of the signal.

### TECHNICAL FIELD

The present disclosure relates generally to an internal combustion engine, and more particularly, to methods and systems for controlling the duty cycle for a metering valve of the internal combustion engine.

### BACKGROUND

An internal combustion engine often includes an electronic controller that controls various aspects of the operation of the engine, including the duty cycle of an inlet metering valve of a fuel pump. For example, the fuel pump pumps fuel from a fuel tank into a common rail of the internal combustion engine, thereby pressurizing the fuel in the common rail, an “on” portion of the duty cycle controlling the position of the inlet metering valve and determining the rate of flow from the fuel pump. One or more fuel injectors inject the pressurized fuel that is in the common rail into one or more cylinders of the engine. When the pressure in the fuel rail is above or below a predetermined pressure, the engine controller controls or adjusts the lengths of the “on” and “off” portions of the duty cycle of the inlet metering valve, such that the fuel pump pumps either less or more fuel into the common rail during the duty cycle, respectively.

U.S. Pat. No. 9,581,102 (the '102 patent) to Stefano discloses a method and control apparatus for operating a fuel-metering valve associated with a fuel pump that is arranged to supply fuel into a fuel rail, where the fuel-metering valve has a valve member and an electric actuator arranged to move the valve member for regulating a fuel flow-rate. The '102 patent describes the use of a proportional-integral controller to control operation of a high-pressure fuel pump. However, the '102 patent does not disclose any method or system capable of effectively and quickly adjusting a duty cycle of a pump to pump more or less fuel into a fuel rail.

The methods and systems of the present disclosure may solve one or more of the problems set forth above and/or other problems in the art, including problems discussed below. The attached claims define the scope of the protection that the present disclosure provided, and the scope of protection is not dependent on the ability to solve any specific problem.

### SUMMARY

In one aspect, an engine system may include: an engine; a common rail fluidly connected to the engine; a fuel pump connected to the common rail by an inlet line, the fuel pump configured to pump fuel through the inlet line to the common rail, the fuel pump including a metering valve; a fuel tank fluidly connected to the fuel pump; and an engine control module configured to provide a signal having a duty cycle to control operation of the metering valve to pump fuel from the fuel tank to the common rail, wherein the duty cycle of the signal is based on a first factor, and the first factor is based on a voltage of the signal and a desired average current to be supplied to the metering valve as a result of the signal.

In another aspect, a mobile machine may include: a chassis; at least one track or wheel connected to the chassis; a fuel pump connected to the chassis, the fuel pump configured to pump fuel, the fuel pump including a metering valve; and an engine control module connected to the chassis, the engine control module configured to provide a signal having a duty cycle to control movement of the metering valve, wherein the duty cycle of the signal is based on a summation of a first factor and a second factor, wherein the first factor is based on at least a voltage of the signal and a desired average current to control the metering valve, and the second factor is based on at least one of a temperature of the fuel and the voltage of the signal.

In another aspect, a method of controlling operation of a metering valve of a fuel pump by an engine control module in an engine system of a machine may include: outputting, by the engine control module, a signal having a duty cycle, wherein the duty cycle of the signal is based on a first factor and a second factor, wherein the first factor is based on a feedforward gain factor, the feedforward gain factor is based on a signal voltage, and the second factor is based on one of a proportional or an integral gain factor; and controlling operation of the metering valve based on the signal.

### BRIEF DESCRIPTION OF THE DRAWINGS

The accompanying drawings, which constitute a part of this specification and the specification otherwise incorporate, illustrate various exemplary embodiments, and, together with the description, serve to explain principles of the disclosed embodiments.

FIG. 1 depicts a schematic view of an exemplary engine system;

FIG. 2 depicts a graph of an exemplary current received by an inlet metering valve, versus time;

FIG. 3 depicts another graph of an exemplary current received by an inlet metering valve, versus time; and

FIG. 4 depicts another graph of an exemplary current received by an inlet metering valve, versus time.

### DETAILED DESCRIPTION

Both the foregoing general description and the following detailed description are exemplary and explanatory only, and are not restrictive of the features, as claimed. As used herein, the terms “comprises,” “comprising,” “having,” including,” or other variations thereof, are intended to cover a non-exclusive inclusion such that a process, method, article, or apparatus that comprises, has, or includes a list of elements does not include only those elements, but may include other elements not expressly listed or inherent to such a process, method, article, or apparatus. Moreover, in this disclosure, relative terms, such as, for example, “about,” “substantially,” “generally,” and “approximately” are used to indicate a possible variation of ±10% in the stated value. In this disclosure, the term “based on,” or any other variation thereof, is intended to cover, for example, “partially based on,” “at least partially based on,” and “based entirely on.”

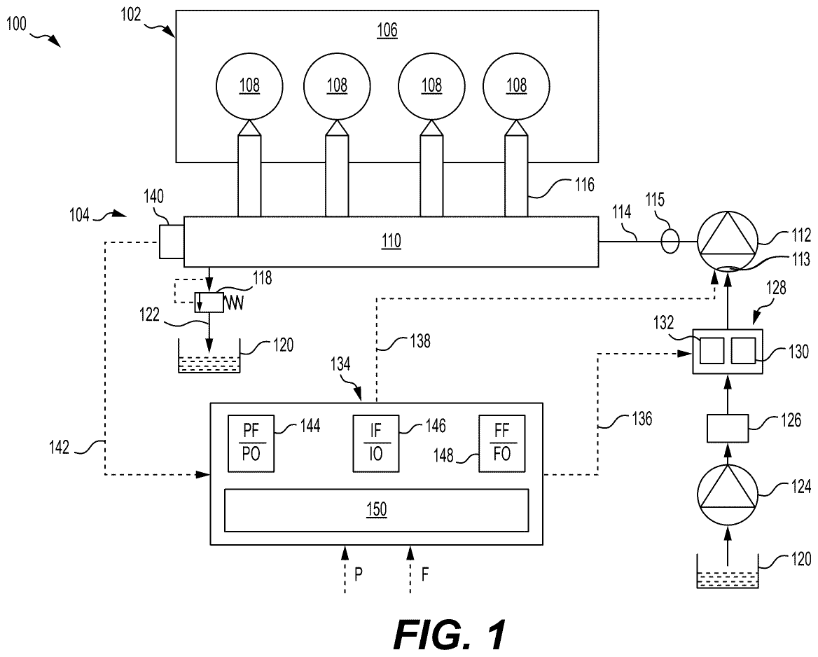

FIG. 1 illustrates a schematic view of an exemplary engine system 100 for use in a machine, such as a mobile machine (e.g., a machine that moves within a job site). Although not limited to any particular machine or mobile machine, the machine with the engine system 100 may include any of a truck, paver, loader, planer, compactor, dozer, dragline, drill, shovel, excavator, handler, grader, pipelayer, tractor, or other machine. The mobile machine may include wheels or tracks, for example. In some instances, the machine may include a chassis, the wheels or tracks connected to the chassis, and components of the engine system 100 connected (either directly or indirectly) to the chassis, or otherwise disposed, positioned, or located within the chassis. In at least some examples, the machine may be a stationary machine, such as a power generating system (e.g., a gen-set).

As FIG. 1 shows, the engine system 100 may include an engine 102 and a high pressure fluid system, such as a common rail fuel system 104, connecting with the engine 102. The engine 102 may include a direct injection compression ignition diesel engine, a spark ignited engine, or an engine with a different ignition strategy. The engine 102 may use gasoline or diesel as a fuel, for example. The engine 102 may include an engine housing 106, and one or more in-line cylinders 108 within the engine housing 106. In some instances, the engine 102 may include a multi-cylinder direct injection compression ignition diesel engine, which includes multiple in-line cylinders 108 in the engine housing 106. FIG. 1 shows an example of the engine system 100 with the engine 102 that includes four (4) in-line cylinders 108, although the engine system 100 is not limited to four in-line cylinders 108, and thus the engine system 100 may include a greater number or lesser number of in-line cylinders 108 than FIG. 1 shows. In some instances, the cylinders 108 may be cylinders other than in-line cylinders.

The common rail fuel system 104 may include a pressurized fuel rail, such as a common rail 110, as FIG. 1 shows. An electronically controlled pump 112 may fluidly connect to the common rail 110 via an inlet line 114 of the electronically controlled pump 112. The electronically controlled pump 112 may include a high pressure electric pump. The electronically controlled pump 112 electrically connects to a power source, such as for example a battery or a high voltage system, which controls operation of the electronically controlled pump 112. The electronically controlled pump 112 includes an inlet metering valve 113. As further described below, based on positions of the inlet metering valve 113 of the electronically controlled pump 112, different amounts of fuel flow to the common rail 110 and pressurize the common rail 110.

A fuel temperature sensor 115 may sense or measure a temperature of fuel pumped through the inlet line 114 into the common rail 110. Although FIG. 1 shows the fuel temperature sensor 115 sensing the temperature of the fuel that is in the inlet line 114, the fuel temperature sensor 115 may sense the temperature of the fuel at other locations within the engine system 100. For example, the fuel temperature sensor 115 may sense the temperature of the fuel upstream of, downstream of, or within any of the inlet line 114, the electronically controlled pump 112, the common rail 110, or any other location within the engine system 100. In some instances, the fuel temperature sensor 115 senses a temperature of the fuel corresponding to an approximate temperature of the fuel at the inlet metering valve 113 of the electronically controlled pump 112.

The engine system 100 may include one or more fuel injectors 116 fluidly connecting to the common rail 110. The number of fuel injectors 116 may correspond to the number of in-line cylinders 108. Thus, FIG. 1 shows four (4) in-line cylinders 108, and the engine system 100 may include four (4) fuel injectors 116. A pressure relief valve 118 may fluidly connect to the common rail 110, thereby to allow fuel to flow into a fuel tank 120 via an outlet line 122, when the pressure within the common rail 110 is greater than a predetermined pressure (e.g., when the common rail 110 is over pressurized). Thus, the pressure relief valve 118 may relieve pressure in the common rail 110. In some instances, the pressure relief valve 118 may include a pilot-operated, one-way valve. As stated, the fuel in the fuel tank 120 may be gasoline or diesel fuel, for example.

As FIG. 1 illustrates, the common rail fuel system 104 may include a low pressure pump 124 fluidly connected to the fuel tank 120. The low pressure pump 124 may pump fuel from the fuel tank 120, through a fuel filter 126, to a flow control valve arrangement 128 fluidly connecting to the common rail 110. The flow control valve arrangement 128 may fluidly connect to the electronically controlled pump 112. The flow control valve arrangement 128 may include a pair of flow control valves (FCVs) 130, 132. In some instances, the flow control valves (FCVs) 130, 132 may include two-way or three-way valves.

As FIG. 1 shows, the common rail fuel system 104 may include an engine control module 134. The engine control module 134 may communicate with the flow control valve arrangement 128 as well as the electronically controlled pump 112, via first and second communication lines 136, 138 respectively.

As stated, the engine control module 134 may control operation of the inlet metering valve 113 of the electronically controlled pump 112 via a pulse width modulation (PWM) signal having a voltage, the pulse width modulation (PWM) signal providing a desired average current based on the voltage, and the pulse width modulation (PWM) signal having a duty cycle. For example, the inlet metering valve 113 may be a normally open valve—that is, a valve biased, such as by a spring, toward a fully open position when not electronically controlled to at least partially or fully closed. When the inlet metering valve 113 is a normally open valve, positions of the inlet metering valve 113 (e.g., amounts that the inlet metering valve 113 closes) generally correspond to average currents that supply charge to a solenoid, thereby generating a magnetic field that actuates the inlet metering valve 113 toward a closed position. Accordingly, when the pulse width modulation (PWM) signal provides a generally higher current, an amount that the inlet metering valve 113 is open generally decreases, or the inlet metering valve 113 completely closes when the average current provided by the pulse width modulation (PWM) signal is above a predetermined value. When fuel flows through the inlet metering valve 113, this is referred to as the “on” portion of the duty cycle, and when fuel does not flow through the inlet metering valve 113, this is referred to as the “off” portion of the duty cycle.

In some instances, the engine control module 134 may compute the duty cycle of the pulse width modulation (PWM) signal with a duty cycle (DC) algorithm, in accordance with the following. For example, the engine control module 134 may include a proportional control portion 144 and an integral control portion 146, which the duty cycle (DC) algorithm uses as inputs. The duty cycle (DC) algorithm may include a proportional gain factor (PF) and an integral gain factor (IF) associated with the proportional control portion 144 and the integral control portion 146, respectively.

In some instances, the engine control module 134 may determine a proportional output (PO) and an integral output (IO) as a function of the proportional gain factor (PF) and the integral gain factor (IF), respectively, based on the voltage of the pulse width modulation (PWM) signal. As FIG. 1 illustrates, the engine control module 134 may include an electronic memory unit 150. The electronic memory unit 150 may store a one-dimensional map, array, spreadsheet, or other data set that correlates values for the proportional gain factor (PF) with voltage, and may store another one-dimensional map, array, spreadsheet, or other data set that correlates values for the integral gain factor (IF) with voltage. The engine control module 134 may determine the proportional output (PO) and the integral output (IO), and store the outputs in the electronic memory unit 150, for use by the duty cycle (DC) algorithm in computing the duty cycle, as described below.

In some instances, the engine control module 134 may determine the proportional output (PO) and the integral output (IO) as a function of the proportional gain factor (PF) and the integral gain factor (IF), respectively, based on the temperature of the fuel which the fuel temperature sensor 115 senses. Thus, the electronic memory unit 150 may store a one-dimensional map, array, spreadsheet, or other data set that correlates values for the proportional gain factor (PF) with temperature, and may store another one-dimensional map, array, spreadsheet, or other data set that correlates values for the integral gain factor (IF) with temperature. The engine control module 134 may determine the proportional output (PO) and the integral output (IO), and store the outputs in the electronic memory unit 150, for use by the duty cycle (DC) algorithm in computing the duty cycle.

In some instances, the engine control module 134 may determine the proportional output (PO) and the integral output (IO) as a function of the proportional gain factor (PF) and the integral gain factor (IF), respectively, based on both the voltage of the pulse width modulation (PWM) signal as well as the fuel temperature. Thus, the electronic memory unit 150 may store a two-dimensional map, array, spreadsheet, or other data set that correlates values for the proportional gain factor (PF) with temperature as well as voltage, and may store another two-dimensional map, array, spreadsheet, or other data set that correlates values for the integral gain factor (IF) based on temperature as well as voltage. The engine control module 134 may determine the proportional output (PO) and the integral output (IO), and store the outputs in the electronic memory unit 150, for use by the duty cycle (DC) algorithm in computing the duty cycle.

In some instances, the duty cycle (DC) algorithm may compute the duty cycle based on a summation of the proportional output (PO) and the integral output (IO). The electronic memory unit 150 may store the computed duty cycle. The engine control module 134 may operate the inlet metering valve 113 in accordance with the stored computed duty cycle. In some instances, the duty cycle (DC) algorithm may compute the duty cycle of the pulse width modulation (PWM) signal based on the summation of the proportional output (PO) and the integral output (IO) multiplied by an error factor, such as an error factor that the electronic memory unit 150 stores. In some instances, the error factor may correspond to the type of machine that includes the engine 102 or the type of engine 102.

The engine control module 134 may include a feedforward control portion 148, which the duty cycle (DC) algorithm uses as an input. The duty cycle (DC) algorithm may include a feedforward factor (FF) associated with the feedforward control portion 148. In some instances, the feedforward factor (FF) acts independent of any feedback error, thereby providing a faster response time as compared to other factors. In some instances, the engine control module 134 may determine a feedforward output (FO) as a function of the feedforward factor (FF), based on the voltage of the pulse width modulation (PWM) signal. In some instances, and the feedforward factor (FF) increases, the duty cycle required to provide a desired average current decreases. The electronic memory unit 150 may store a one-dimensional map, array, spreadsheet, or other data set that correlates values for the feedforward factor (FF) with voltage. The engine control module 134 may determine the feedforward output (FO), and store the output in the electronic memory unit 150, for use by the duty cycle (DC) algorithm in computing the duty cycle. In some instances, the electronic memory unit 150 may store one or more maps, arrays, spreadsheets, or data sets corresponding to different voltages of the pulse width modulation (PWM) signal resulting in the average current supplied to the inlet metering valve 113, such as but not limited to voltages of 6 volts, 9 volts, 12 volts, 13 volts, 18 volts, 24 volts, 25 volts, 32 volts, or some other voltage.

In some instances, the engine control module 134 may determine the feedforward output (FO) as a function of the feedforward factor (FF) based on the desired average current supplied to the inlet metering valve. The electronic memory unit 150 may store a one-dimensional map, array, spreadsheet, or other data set that correlates values for the feedforward factor (FF) with the desired average current. The engine control module 134 may determine the feedforward output (FO), and store the output in the electronic memory unit 150, for use by the duty cycle (DC) algorithm in computing the duty cycle.

In some instances, the engine control module 134 may determine the feedforward output (FO) as a function of the feedforward factor (FF) based on both the voltage of the pulse width modulation (PWM) signal and the desired average current supplied to the inlet metering valve 113 based on of the pulse width modulation (PWM) signal. The electronic memory unit 150 may store a two-dimensional map, array, spreadsheet, or other data set that correlates values for feedforward factor (FF) with voltage as well as the desired average current. The engine control module 134 may determine the feedforward output (FO), and store the output in the electronic memory unit 150, for use by the duty cycle (DC) algorithm in computing the duty cycle.

In some instances, the duty cycle (DC) algorithm may compute the duty cycle based on a summation of the proportional output (PO), the integral output (IO), and the feedforward output (FO). In some instances, the duty cycle (DC) algorithm may compute the duty cycle of the pulse width modulation (PWM) signal based on the summation of the proportional output (PO) and the integral output (IO) multiplied by the error factor, and the feedforward output (FO). In some instances, the duty cycle (DC) algorithm may compute the duty cycle of the pulse width modulation (PWM) signal based on the summation of the proportional output (PO) and the integral output (IO) multiplied by the error factor, and the feedforward output (FO) multiplied by a second error factor, which the electronic memory unit 150 stores. In some instances, the second error factor may correspond to the type of machine that includes the engine 102, for example.

In some instances, the duty cycle (DC) algorithm may use a previous duty cycle value as an input. In some instances, the engine control module 134 may compute an integral of one or more previous duty cycle values, and store the integral or integrals in the electronic memory unit 150. In some instances, engine control module 134 may compute a derivative of one or more previous duty cycle values, and store the derivative or derivatives in the electronic memory unit 150. In some instances, the duty cycle (DC) algorithm may compute the duty cycle based on a summation of the proportional output (PO), the integral output (IO), the feedforward output (FO), and the one or more integrals or derivatives of the previous duty cycle values. In some instances, the duty cycle (DC) algorithm may compute the duty cycle of the pulse width modulation (PWM) signal based on the summation of the proportional output (PO) and the integral output (IO) multiplied by an error factor, the feedforward output (FO), and the integrals and/or derivatives of the previous duty cycle values.

### Industrial Applicability

As discussed, in some instances the duty cycle of the pulse width modulation (PWM) signal computed by the duty cycle (DC) algorithm is based on the fuel temperature. Thus, the duty cycle of the pulse width modulation (PWM) signal may correspond to and account for viscosity as well as bulk modulus of the fuel, either or both of which may vary depending on the temperature of the fuel. Also as discussed, in some instances the duty cycle of the pulse width modulation (PWM) signal is based on the voltage of the pulse width modulation (PWM) signal and the desired average current to be supplied to the inlet metering valve 113, thereby providing more accurate control and a quicker response time of the position of the inlet metering valve. For example, the engine control module 134 programmed as above may take only one to two duty cycles to change the desired average current received by the inlet metering valve 113 from a near minimum value to a near maximum value. In contrast, an engine control module programmed to provide a signal based on a simple proportional-integral calculation may take from ten to twenty duty cycles to change the desired average current received by the inlet metering valve from a near minimum to a near maximum value.

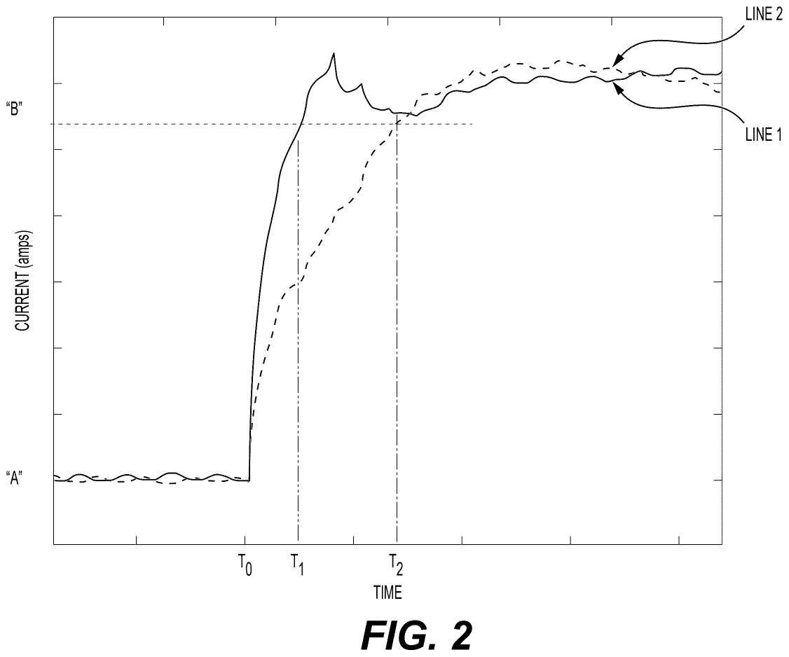

FIG. 2 is a graph of an exemplary average current received by an inlet metering valve (Y-axis), versus time (X-axis). Current waveform 1 of FIG. 2 illustrates the average current supplied to the inlet metering valve resulting from a signal, when an engine control module computes the duty cycle of the signal as set forth above—e.g., based on a feedforward factor that is based on voltage and current, and based on proportional and integral factors that are themselves based on voltage and fuel temperature (referred to as “feedforward control”)—as a function of time.

Current waveform 2 of FIG. 2 illustrates the average current supplied to an inlet metering valve resulting from a signal, when an engine control module computes a duty cycle of the signal based a simple proportional-integral calculation (referred to as “proportional-integral control”), as a function of time. As FIG. 2 illustrates, during “feedforward control” the average current received by the inlet metering valve increases from current level “A” (e.g., a minimum average current level) to current level “B” (e.g., a desired average current level or a current level within a suitable margin of error from the desired current level) during the time interval extending between T₀ and time T₁, while during “proportional-integral control” the average current received by the inlet metering valve increases from current level “A” to current level “B” during the time interval extending between time T₀ and time T₂, where the time interval between T₀ and time T₁ is less than half of the time interval between T₀ and time T₂.

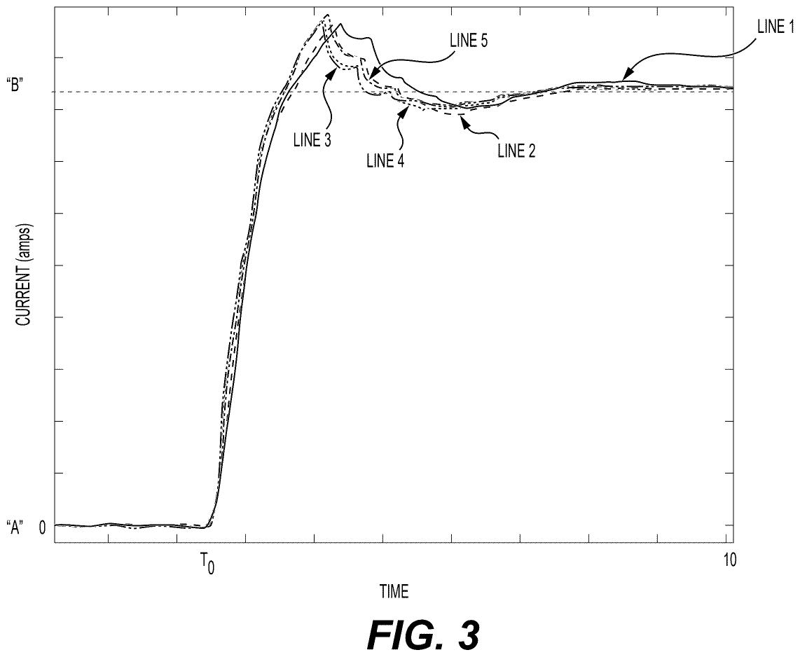

FIG. 3 is a graph of an exemplary average current received by an inlet metering valve (Y-axis), versus time (X-axis). Current waveform 1 of FIG. 3 illustrates the average current supplied to an inlet metering valve resulting from a signal, when an engine control module computes a duty cycle of the signal as set forth above (referred to as “feedforward control”) as a function of time, when the voltage of the signal is 9 volts. Current waveform 2 of FIG. 3 illustrates the average current supplied to an inlet metering valve as a result of “feedforward control,” as a function of time, when the voltage of the signal is 13 volts. Current waveform 3 of FIG. 3 illustrates the average current supplied to an inlet metering valve as a result of “feedforward control,” as a function of time, when the voltage of the signal is 18 volts. Current waveform 4 of FIG. 3 illustrates the average current supplied to an inlet metering valve as a result of “feedforward control,” as a function of time, when the voltage of the signal is 25 volts. Current waveform 5 of FIG. 3 illustrates the average current supplied to an inlet metering valve resulting from “feedforward control” as a function of time, when the voltage of the signal is 32 volts. As FIG. 3 shows, comparing current waveforms 1-5 to one another illustrates that profiles of the waves are similar to one another, regardless of the voltage of the signal, as each of the waveforms increases from current level “A” (e.g., a minimum average current level) at time T₀, to current level “B” (e.g., a desired average current level or a current level within a suitable margin of error from the desired current level) over a similar time period.

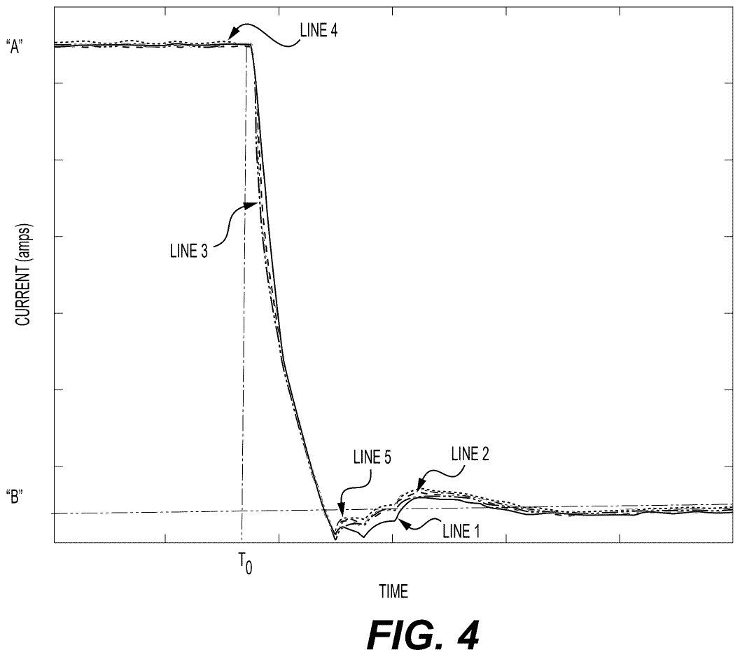

FIG. 4 is a graph of an exemplary average current received by an inlet metering valve (Y-axis), versus time (X-axis). Current waveform 1 of FIG. 4 illustrates the average current supplied to an inlet metering valve resulting from a signal, when an engine control module computes a duty cycle of the signal as set forth above (referred to as “feedforward control”) as a function of time, when the voltage of the signal is 9 volts. Current waveform 2 of FIG. 4 illustrates the average current supplied to an inlet metering valve as a result of “feedforward control,” as a function of time, when the voltage of the signal is 13 volts. Current waveform 3 of FIG. 4 illustrates the average current supplied to an inlet metering valve as a result of “feedforward control,” as a function of time, when the voltage of the signal is 18 volts. Current waveform 4 of FIG. 4 illustrates the average current supplied to an inlet metering valve as a result of “feedforward control,” as a function of time, when the voltage of the signal is 25 volts. Current waveform 5 of FIG. 4 illustrates the average current supplied to an inlet metering valve resulting from “feedforward control” as a function of time, when the voltage of the signal is 32 volts. As FIG. 4 shows, comparing current waveforms 1-5 to one another illustrates that profiles of the waves are similar to one another, regardless of the voltage of the signal, as each of the waveforms decreases from current level “A” (e.g., a desired average current level or a current level within a suitable margin of error from the desired current level) at time T₀, to current level “B” (e.g., a minimum average current level) over a similar time period.

Thus, the engine control module 134 programmed with the duty cycle (DC) algorithm that computes the duty cycle of the pulse width modulation (PWM) signal, as described above, may be included in any type of machine, to control the operation and adjustment of the inlet metering valve 113. The engine control module 134 programmed to compute the duty cycle based on the feedforward factor that is based on voltage and average current, and on the proportional and integral factors based on voltage and fuel temperature, may provide advantages as compared to an engine control module programmed to compute duty cycle based on a simple proportional-integral algorithm. For example, the above-described engine control module 134 may operate the inlet metering valve 113 of the electronically controlled pump 112 to avoid both excessive pressure within the common rail fuel system 104, including within the common rail 110, caused by excessive pumping of fuel into the common rail 110 by the electronically controlled pump 112, as well as under pressurization of the common rail 110 caused by the electronically controlled pump 112 not pumping enough fuel into the common rail 110, each of which may result from a slow response of the inlet metering valve 113 of the electronically controlled pump 112 when adjusting the amount of fuel pumped into the common rail 110. The engine control module 134 described and illustrated above may operate the inlet metering valve 113 such that the inlet metering valve 113 has a shorter response time and thus may more quickly adjust the amount fuel pumped into the common rail 110. Accordingly, operation of the inlet metering valve 113 by the engine control module 134 may reduce emissions, increase performance, and increase durability of the engine 102.

It will be apparent to those skilled in the art that various modifications and variations can be made to the disclosed method and system without departing from the scope of the disclosure. Other embodiments of the method and system will be apparent to those skilled in the art from consideration of the specification and practice of the apparatus and system disclosed herein. It is intended that the specification and examples be considered as exemplary only, with a true scope of the disclosure being indicated by the following claims and their equivalents.

What is claimed is:

1. An engine system comprising:
an engine;
a common rail fluidly connected to the engine;
a fuel pump connected to the common rail by an inlet line, the fuel pump configured to pump fuel through the inlet line to the common rail, the fuel pump including a metering valve;
a fuel tank fluidly connected to the fuel pump; and
an engine control module configured to provide a signal having a duty cycle to control operation of the metering valve to pump fuel from the fuel tank to the common rail,
wherein the duty cycle of the signal is based on a first factor, and the first factor is based on a voltage of the signal and a desired average current to be supplied to the metering valve as a result of the signal.

2. The engine system of claim 1, wherein the duty cycle is based on a summation of the first factor and a second factor.

3. The engine system of claim 1, wherein the engine control module is configured to provide the signal having the duty cycle to operate the metering valve.

4. The engine system of claim 1, wherein the engine control module is configured to provide the signal having the duty cycle that is based on the first factor and a second factor, to operate the metering valve,
wherein the second factor is based on a temperature of the fuel.

5. The engine system of claim 1, wherein the engine control module is configured to provide the signal having the duty cycle that is based on the first factor and a second factor, to operate the metering valve,
wherein the second factor is based on the voltage of the signal and a temperature of the fuel.

6. The engine system of claim 1, wherein the engine control module is configured to provide the signal having the duty cycle that is based on the first factor and a second factor, to operate the metering valve,
wherein the second factor is based on a proportional gain factor.

7. The engine system of claim 1, wherein the engine control module is configured to provide the signal having the duty cycle that is based on a summation of the first factor and a second factor, to operate the metering valve,
wherein the second factor is based on a proportional gain factor, and the proportional gain factor is based on the voltage of the signal and a temperature of the fuel.

8. The engine system of claim 1, wherein the engine control module is configured to provide the signal having the duty cycle that is based on a summation of the first factor and a second factor, to operate the metering valve,
wherein the second factor is based on an integral gain factor.

9. The engine system of claim 1, wherein the engine control module is configured to provide the signal having the duty cycle that is based on a summation of the first factor and a second factor, to operate the metering valve,
wherein the second factor based on an integral gain factor, and the integral gain factor is based on the voltage of the signal and a temperature of the fuel.

10. The engine system of claim 1, wherein the engine control module is configured to provide the signal having the duty cycle that is based on a summation of the first factor, a second factor, and a third factor, to operate the metering valve,
wherein the second factor is based on a proportional gain factor, the proportional gain factor is based on the voltage of the signal and a temperature of the fuel, the third factor is based on an integral gain factor, and the integral gain factor is based on the voltage of the signal and the temperature of the fuel.

11. The engine system of claim 1, wherein the engine control module is configured to provide the signal having the duty cycle that is based on a summation of the first factor, a second factor, and a third factor, to operate the metering valve,
wherein each of the second factor and the third factor is based on the voltage of the signal and a temperature of the fuel, wherein the second factor is different than the third factor.

12. The engine system of claim 1, wherein the engine control module is configured to provide the signal having the duty cycle that is based on a summation of the first factor, a second factor, and a third factor, to operate the metering valve,
wherein the second factor is based on a proportional gain factor, and the third factor is based on an integral gain factor.

13. The engine system of claim 1, further comprising:
a temperature sensor configured to sense a temperature of the fuel,
wherein the engine control module is configured to provide the signal having the duty cycle that is based on a summation of the first factor, a second factor, and a third factor, to operate the metering valve,
wherein the second factor is based on a proportional gain factor, the proportional gain factor is based on the voltage of the signal and the temperature of the fuel, the third factor is based on an integral gain factor, and the integral gain factor is based on the voltage of the signal and the temperature of the fuel.

14. The engine system of claim 1, further comprising:
a temperature sensor connected between the fuel pump and the common rail, the temperature sensor configured to sense a temperature of the fuel in the inlet line,
wherein the engine control module is configured to provide the signal having the duty cycle that is based on a summation of the first factor, a second factor, and a third factor, to operate the metering valve,
wherein the second factor is based on a proportional gain factor, the third factor is based on an integral gain factor, and at least one of the proportional gain factor and the integral gain factor is based on the voltage of the signal and the temperature of the fuel.

15. A mobile machine, comprising:
a chassis;
at least one track or wheel connected to the chassis;
a fuel pump connected to the chassis, the fuel pump configured to pump fuel, the fuel pump including a metering valve; and
an engine control module connected to the chassis, the engine control module configured to provide a signal having a duty cycle to control movement of the metering valve,
wherein the duty cycle of the signal is based on a summation of a first factor and a second factor, wherein the first factor is based on at least a voltage of the signal and a desired average current to control the metering valve, and the second factor is based on at least one of a temperature of the fuel and the voltage of the signal.

16. The mobile machine of claim 15, wherein the second factor is one of a proportional gain factor or an integral gain factor.

17. The mobile machine of claim 15, wherein the second factor is one of a proportional gain factor or an integral gain factor, and the second factor is based on the voltage of the signal and the temperature of the fuel.

18. A method of controlling operation of a metering valve of a fuel pump by an engine control module in an engine system of a machine, comprising:
outputting, by the engine control module, a signal having a duty cycle, wherein the duty cycle of the signal is based on a first factor and a second factor,
wherein the first factor is based on a feedforward gain factor, the feedforward gain factor is based on a signal voltage, and the second factor is based on one of a proportional or an integral gain factor; and
controlling operation of the metering valve based on the signal.

19. The method of claim 18, wherein the outputting comprises outputting the signal having the duty cycle that is based on a summation of the first factor, the second factor, and a third factor,
wherein the second factor is based on an integral gain factor, the third factor is based on a proportional gain factor, and at least one of the proportion gain factor or the integral gain factor is based on the signal voltage and fuel temperature.

20. The method of claim 18, wherein the outputting comprises outputting the signal having the duty cycle that is based on a summation of the first factor and the second factor,
wherein the second factor is based on the signal voltage.
